(19) United States
(12) Patent Application Publication
(10) Pub. No.: US 2025/0087807 A1
(43) Pub. Date: Mar. 13, 2025

(54) IMPACT ATTENUATION FOR ENERGY STORAGE SYSTEMS

(71) Applicant: Tesla, Inc., Austin, TX (US)

(72) Inventors: Malcolm Burgess, Mountain View, CA (US); Karim Najjar, Redwood City, CA (US); Xiaowei Zhang, Milpitas, CA (US); Timothy Lai, Milpitas, CA (US)

(21) Appl. No.: 18/722,402

(22) PCT Filed: Jan. 4, 2023
(86) PCT No.: PCT/US2023/010108

§ 371 Date: Jun. 20, 2024

Related U.S. Application Data
(60) Provisional application No. 63/297,190, filed on Jan. 6, 2022.

(51) Int. Cl. H01M 50/24; H01M 50/231; H01M 50/242; H01M 50/244

(52) U.S. Cl. CPC H01M 50/24; H01M 50/231; H01M 50/242; H01M 50/244; H01M 2220/20

(57) ABSTRACT

The present disclosure generally relates to a battery pack for an electric vehicle. In some implementation examples, the battery pack has an array of battery cells and a battery pack enclosure for holding the array of battery cells. The battery pack enclosure has a top surface above the array of battery cells. An impact attenuation layer can be integrated into at least a portion of the top surface of the battery pack enclosure. The impact attenuation layer has a first sub-layer and a second sub-layer. The first sub-layer has a first puncture resistance attribute and a first impact resistance attribute and the second sub-layer has a second puncture resistance attribute and a second impact resistance attribute. The first puncture resistance attribute is higher than the second, puncture resistance attribute and the first impact resistance attribute is lower than the second impact resistance attribute.

### CROSS-REFERENCE TO RELATED APPLICATION

This application is a non-provisional of, and claims priority to, U.S. Provisional Patent Application No. 63/297,190, entitled “IMPACT ATTENUATION FOR ENERGY STORAGE SYSTEMS,” filed on Jan. 6, 2022, which is hereby incorporated by reference in its entirety and for all purposes.

### BACKGROUND

Generally described, a number of devices or components may be powered, at least in part, by an electric power source. In the context of vehicles, electric vehicles may be powered, in whole or in part, by a power source. The power source for an electric vehicle may be generally referred to as a “battery” or “battery pack,” which can represent individual battery cells, or cells, or a combination of battery modules. In some approaches, a cluster of cells can be combined or organized into individual modules and a cluster of modules can be further combined or organized as a battery pack. The power sources for electric vehicles can be installed and maintained in a battery pack configuration. Similar approaches/terminology can apply to grid storage application for collecting, storing, and distributing energy.

Electric vehicles typically require a large multiple of power, sometimes as much as a thousand times stronger than that of a typical consumer device, such as a mobile device. To achieve these power requirements, the battery packs of electric vehicles typically include a large, dense arrangement of individual cells. The composition and performance of the battery pack will depend on the characteristics of the individual battery cells, the total number of individual cells that are incorporated into the battery pack, and configurations/orientations of the cells and ancillary components into modules or the battery pack. The battery pack may represent one of the most expensive and massive assemblies in the context of most electric vehicle transportation and grid storage applications.

### BRIEF DESCRIPTION OF THE DRAWINGS

Generally described, a variety of vehicles, such as electric vehicles, hybrid vehicles, etc., can require some connection to an external power source to at least partially recharge internal power sources, such as a battery pack. In certain scenarios, the state of health or other characterization of operability of electric vehicle resources, such as the battery pack, can assist in the operation and maintenance of vehicles.

FIG. 1A illustrates a perspective view of a combination of a unitary battery pack having an integrated impact attenuation layer with a vehicle frame in accordance with some embodiments of the present disclosure.

FIG. 1B illustrates a top-down view of a combination of a unitary battery pack having an integrated impact attenuation layer with a vehicle frame in accordance with some embodiments of the present disclosure.

FIG. 2 depicts an example exploded view of a unitary battery pack having an integrated impact attenuation layer according to some embodiments of the present disclosure.

FIG. 3A illustrates a top surface of a unitary battery pack with an integrated impact attenuation layer in accordance with some embodiments of the present disclosure.

FIG. 3B illustrates a side view of a portion of a unitary battery pack having an integrated impact attenuation layer including a first sub-layer and a second sub-layer according to some embodiments of the present disclosure.

FIGS. 4A, 4B and 4C depict block diagrams representative of the components of a unitary battery pack illustrating examples of integrating impact attenuation layers into unitary battery packs through representations of cross-sectional views in accordance with embodiments of the present disclosure.

FIG. 5 depicts a cutaway view of a portion of a unitary battery pack illustrating an array of battery cells forming a portion of a battery pack and an integrated impact attenuation layer in accordance with embodiments of the present disclosure.

### DETAILED DESCRIPTION

Generally described, one or more aspects of the present disclosure relate to energy storage systems including a unitary battery pack or module. In some embodiments, a unitary battery pack may be formed and used as a part of the structural support for a vehicle frame. In one aspect, the unitary battery pack can have, or be integrated with, a top surface that includes at least an impact attenuation layer. More specifically, in an illustrative embodiment, the configuration of the impact attenuation layer may include a first sub-layer and a second sub-layer. The first sub-layer and the second sub-layer may be made of different materials. The first sub-layer may have a relatively larger strength attribute or stiffness than the second sub-layer. The second sub-layer may have a relatively larger energy absorption attribute than the first sub-layer.

Traditional top surfaces associated with unitary battery packs may be made of various materials. Typically, the same materials are used for making the outer surfaces or other parts of the unitary battery packs, such as the outer sides or outer bottom surfaces. Such approaches can be deficient in that force applied to any portion of the integrated, unitary battery pack, such as a force to the top surface of the unitary battery pack is localized in nature. For example, in traditional implementations, it has been found that approximately 65% of the energy is impacted on the battery cells adjacent to a point of contact of a force while only 7% of the force may be experienced at neighboring cells Such effects generally mean that absent additional protection, portions of a unitary battery pack may be damaged during forces experienced during operation of a vehicle. Still further, other implementations of top surfaces that may be vulnerable to point of contact forces may include the additional implementation of air gaps or other intermediate layers that allows for deformation of the traditional top surface but avoiding the application of a force directly to the battery cells. The need for additional air gaps or intermediate layers, however, decreases the area available to hold an array of battery cells (e.g., individual cells). This can limit the size of the array of battery cells or the individual cells that form the battery pack. In turn, this results in a battery pack with less electric power capacity. Additionally, traditional attempts at reinforcement can result in increased weight of the vehicle or cost of manufacturing.

To address at least a portion of these deficiencies, the illustrative integrated, unitary battery pack can further include one or more characteristics or features that can be combined within the structural frame holding battery modules or an array of battery cells, generally referred to as a battery or battery pack. In one aspect, the unitary battery pack can be associated with or integrated with a top surface that includes at least an impact attenuation layer. More specifically, in an illustrative embodiment, the configuration of the impact attenuation layer includes a first sub-layer of a first material that has relatively larger strength attributes or stiffness than traditional plastic or polymer battery pack shell materials. The first impact attenuation layer may be made from, for example, steel, aluminum, alloy or other kinds of metallic material. The impact attenuation layer may also include a second sub-layer of a second material that has a relatively larger energy absorption attribute, such as various foams or plastics including but not limited to polypropylene, epoxy, polyurethane or other suitable alternatives. In some embodiments, the first sub-layer may be above the second sub-layer. In other embodiments, the second sub-layer may be above the first sub-layer. Illustratively, the first and second sub-layers, regardless of configuration, may be bonded.

Illustratively, one or more aspects of the present application can include the design or specification of thicknesses of at least the first sub-layer or the second sub-layer. For example, the thickness of individual sub-layers or other attributes may be selected based on an illustrative modeling and selection process. In some embodiments, the thickness of the first sub-layer may be 0.5 millimeter (mm), 1.0 mm, 1.5 mm, 2.0 mm, 2.5 mm, 3.0 mm and any values in between. Additionally, in some embodiments, the thickness of the second sub-layer may be 4.0 mm, 8.0 mm, 8.5 mm, 9.0 mm, 9.5 mm, 10.0 mm, 10.5 mm, 11.0 mm, 13.0 mm, 15.0 mm and any values in between. Accordingly, the thickness of the first sub-layer and the second sub-layer may be dependent based on the specification of the attributes of the impact attenuation layer, the individual attributes of the first sub-layer (e.g., specified stiffness), the individual attributes of the second sub-layer (e.g., specific energy absorption), and various combinations thereof.

In still other embodiments, the thickness of the first sub-layer may be relatively uniform throughout the entirety of the impact attenuation layer. In other embodiments, the thickness of the first sub-layer may be non-uniform, including the allocation of different thicknesses of the first sub-layer based on anticipated locations of potential forces, a modeled strength requirement or other factors. In a similar manner, the thickness of the second sub-layer may also be relatively uniform throughout the entirety of the impact attenuation layer. In other embodiments, the thickness of the second sub-layer may be non-uniform based on anticipated forces, a modeled energy absorption requirement or other factors, such as the need for acoustic dampening. Accordingly, illustrative impact attenuation layers may include combinations of uniform and non-uniform thickness of the first and second sub-layers.

One skilled in the relevant art will appreciate that the identified thicknesses of the sub-layers are illustrative in nature and should not be construed as limiting. The sub-layers may also be illustratively assembled and bonded to other components of a vehicle as disclosed herein. Further, as used herein, the term “battery pack” and the term “unitary battery pack” both refer to an energy storage system having a plurality of battery cells (e.g., an array of battery cells) and a structure (e.g., a battery pack enclosure) for enclosing or protecting the plurality of battery cells. The battery pack enclosure may have at least one of a top surface, a bottom surface or several side surfaces. For example, the battery pack enclosure may have only a top surface that is bonded with the plurality of battery cells. As another example, the battery pack enclosure may have a top surface and a bottom surface with the plurality of battery cells placed between the top surface and the bottom surface. Additionally, and optionally, the battery pack enclosure may have a top surface, a bottom surface and several side surfaces that fully surround the battery cells.

In some examples, a bottom surface of a battery pack may have attributes or properties similar to those of the top surface described in accordance with the present application. In some embodiments, the bottom surface may be formed from a honeycomb or ridged surface which is mechanically linked to cells within the battery pack. The bottom surface may be designed so that it can absorb and distribute impact energy from below the pack without allowing the impact to damage sensitive battery materials or breach the battery pack. In one embodiment, the bottom surface is made from a material that has sufficient stiffness and strength to support the battery cells and react to the aforementioned vehicle stresses, but also can deform in response to a road strike from below that would otherwise cause a break within the battery pack. In addition, the series of ridges can allow gases to escape from the battery pack should damage occur to a particular battery cell, or in the event of a runaway thermal event occurring within one or more cells of the battery pack. In other embodiments, the bottom surface may include compressible material that is deformable in response to the application of a physical force.

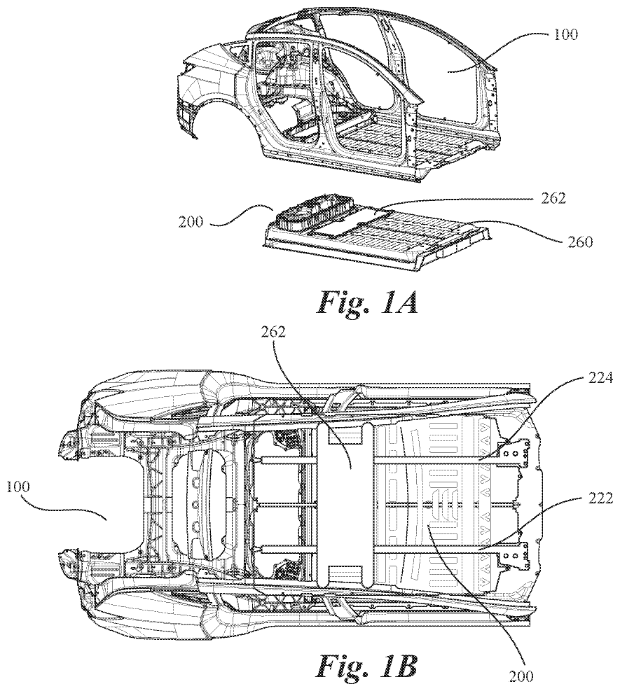

FIG. 1A illustrates a perspective view of a combination of a unitary battery pack 200 having an integrated impact attenuation layer 262 with a vehicle frame 100 in accordance with some embodiments of the present disclosure. As shown in FIG. 1A, an impact attenuation layer 262 is integrated with a top surface 260 of the unitary battery pack 200. The dimensions of the impact attenuation layer 262 can illustratively match the contours or design specifications of the integrated, unitary battery pack 200, including various cutout sections and or overlapping sections that are not illustrated here. As show in FIG. 1A, a top surface 260 of the unitary battery pack 200 can include ribs or other formations to assist in various additional or alternative vehicle functions, including mounting surfaces, guides, and the like. Additionally, the dimensions of the impact attenuation layer 262 can match the contours or design specifications of other vehicle components.

FIG. 1B illustrates a top-down view of a combination of the unitary battery pack 200 having an integrated impact attenuation layer 262 with the vehicle frame 100 in accordance with some embodiments of the present disclosure. As illustrated in FIG. 1B, the unitary battery pack 200 may form a portion of a floorboard of a vehicle. Additionally, in some embodiments, the unitary battery pack 200 is bonded to some portions of the vehicle frame 100 or other parts of an electric vehicle. As shown, the unitary battery pack 200 also has structural members 222 and 224, which will be described later in greater detail.

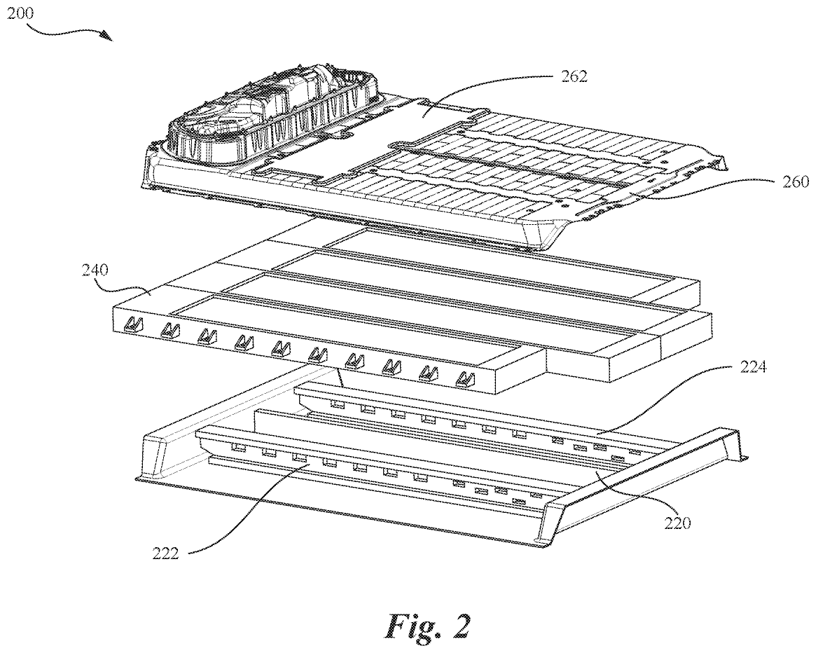

FIG. 2 depicts an example exploded view of a unitary battery pack 200 having an integrated impact attenuation layer 262 according to some embodiments of the present disclosure. The unitary battery pack 200 has a top surface 260, a bottom surface 220 and an array of battery cells 240 that includes a plurality of battery cells mounted between the top surface 260 and the bottom surface 220. The bottom surface 220 has a structural member 222 and a structural member 224. The structural members 222 and 224 may separate out battery cells within the array of battery cells 240. In some embodiments, the structural members 222 and 224 can provide additional structural supports for the unitary battery pack 200 and form part of the structural support for the unitary battery pack 200. In some embodiments, no structural members are present on the bottom surface 220. In other embodiments, the bottom surface 220 may be removed or minimized as long as the top surface 260 is adequately bonded with the array of battery cells 240. As such, the cost of manufacturing may be reduced. In still other embodiments, the array of battery cells 240 can be bonded with side surfaces (not shown in FIG. 2) surrounding the array of battery cells 240 using adhesive techniques. Still further, in other embodiments, additional materials, such as potting materials, may be added to the unitary battery pack, such as for cooling functionality, and electrical isolation/insulation. As such, the bottom surface 220 may also be removed or minimized. As shown in FIG. 2, the top surface 260 has an impact attenuation layer 262, which will be described in detail below. Illustratively, the impact attenuation layer 262 is integrated with the top surface 260 of the unitary battery pack 200.

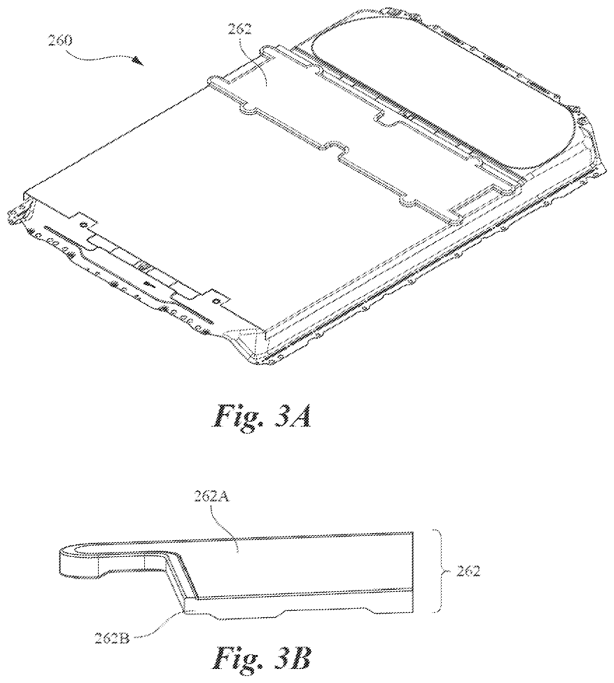

FIG. 3A depicts an example top surface 260 of a unitary battery pack with an integrated impact attenuation layer 262 in accordance with some embodiments of the present disclosure. As illustrated, the top surface 260 has an impact attenuation layer 262. As illustrated, the impact attenuation layer 262 shown in FIG. 3A covers only a portion of the top surface 260. In one embodiment, the placement and surface area of the impact attenuation layer 262 can correspond to areas of the top surface 260 characterized as most likely to receive an impact force, areas that correspond to other structures of the vehicle (such as seating areas, cargo holds, etc.), or a combination thereof. In other embodiments, the impact attenuation layer 262 may cover the entire or most of the top surface 260. Additionally, the impact attenuation layer 262 may be of different shapes and occupy smaller or larger area than shown in FIG. 3A. Alternatively, the impact attenuation layer 262 may be separated into a plurality of individual impact attenuation layer components placed at different locations on the top surface 260. Illustratively, the impact attenuation layer 262 (and components thereof) may be bonded to the top surface 260, using a variety of materials and techniques.

FIG. 3B illustrates a side view of a portion of a unitary battery pack having an integrated impact attenuation layer 262 according to some embodiments of the present disclosure. The impact attenuation layer 262 has a first sub-layer 262A and a second sub-layer 262B. As illustrated in FIG. 3B, the first sub-layer 262A is above the second sub-layer 262B. The first sub-layer 262A may illustratively be made of steel, aluminum, alloy or other combinations of metallic materials. The second sub-layer 262B may be made of polypropylene, epoxy, polyurethane or other combinations of plastic or foam materials. In some embodiments, the materials used to form the first sub-layer 262A and the second sub-layer 262B are selected such that a puncture resistance (or a puncture resistance attribute) of the first sub-layer 262A is higher or greater than a puncture resistance of the second sub-layer 262B. Specifically, the first sub-layer 262A has a greater ability to inhibit the intrusion of an object or force foreign to the top surface 260 than the second sub-layer 262B. In contrast, an impact resistance (or an impact resistance attribute) of the first sub-layer 262A is lower than an impact resistance of the second sub-layer 262B. In other words, the second sub-layer 262B has a greater ability than the first sub-layer 262A to absorb shock or impact energy without fracturing or breaking.

In some embodiments, the thickness of the first sub-layer 262A may be between 0.5 mm to 3.0 mm. Additionally, in some embodiments, the thickness of the second sub-layer 262B may be between 4.0 mm to 15.0 mm. Although the thickness of the first sub-layer 262A and the second sub-layer 262B are illustratively uniform, in some embodiments, the thickness of at least one of the first sub-layer 262A or the second sub-layer 262B can be non-uniform. In one embodiment, the thickness of the first sub-layer 262A is uniform and the thickness of the second sub-layer 262B is uniform. In another embodiment, the thickness of the first sub-layer 262A is non-uniform and the thickness of the second sub-layer 262B is uniform. In still another embodiment, the thickness of the first sub-layer 262A is uniform and the thickness of the second sub-layer 262B is non-uniform. In yet another embodiment, the thickness of the first sub-layer 262A is non-uniform and the thickness of the second sub-layer 262B is non-uniform. In some examples, the uniformity of the thickness of the first sub-layer 262A and the second sub-layer 262B may be determined based on the likelihood of encountering of external impact. For example, the first sub-layer 262A may be thicker in some part of the top surface 260 where external force is more likely to strike and may be thinner in other part of the top surface 260 where external force is less likely to strike. In other embodiments, there may be no impact attenuation layer 262 on portions of the top surface where neither foreign objects nor impact energy are likely to strike. As such, the impact attenuation layer 262 can be configured based on anticipated forces applied to the unitary battery pack/vehicle to protect battery cells below the top surface 260 at a moderate cost.

In addition to protecting a battery pack from external force or impact, the impact attenuation layer 262 may further provide acoustic dampening for a vehicle. In some embodiments, the material used to make the second sub-layer 262B is selected such that the second sub-layer 262B can retain both desired impact resistance attribute and acoustic dampening attribute. In some embodiments, an acoustic dampening attribute of the second sub-layer 262B may be higher or greater than that of the first sub-layer 262A. Specifically, the selection of materials and configuration of material depth of the second sub-layer 262B has a greater capability of absorbing sound or noise than the first sub-layer 262A. In some embodiments, the thickness of the second sub-layer 262B can be varied for providing adequate level of acoustic dampening. For example, the second sub-layer 262B may be thicker in area of the top surface 260 that is closer to source of noise, such as the area of the top surface 260 that is closer to the front or rear wheels of the vehicle.

As described previously, the top surface 260 of a unitary battery pack may form a portion of a floorboard of a vehicle (e.g., as shown in FIG. 1B). Advantageously, the acoustic dampening attribute of the second sub-layer 262B may allow the removal of a vehicle carpet foam that is traditionally deployed on areas the floorboard of the vehicle where acoustic dampening is desired. By removing the vehicle carpet foam, the height of the vehicle cabin will not be decreased and the cost of manufacturing can also be reduced.

As illustrated in FIGS. 1A, 1B, 2, 3A and 3B, the impact attenuation layer 262 is shown as being integrated with a top surface 260 of a unitary battery pack. In other embodiments, the impact attenuation layer 262 may be deployed or integrated with other parts of a vehicle. For example, referring to FIG. 2, the impact attenuation layer 262 is shown integrated with the top surface 260 of the unitary battery pack 200. Alternatively, the impact attenuation layer 262 can be integrated with the bottom surface 220 of the unitary battery pack 200. More specifically, the impact attenuation layer 262 can be deployed above or underneath the bottom surface 220 of the unitary battery pack 200 to protect the unitary battery pack 200 from external force coming from below the unitary battery pack 200 or from the ground. For another example, referring to FIG. 1A, the impact attenuation layer 262 is shown integrated with the top surface 260 of the unitary battery pack 200. Alternatively, the impact attenuation layer 262 can be integrated with a portion of a floorboard of the vehicle frame 100.

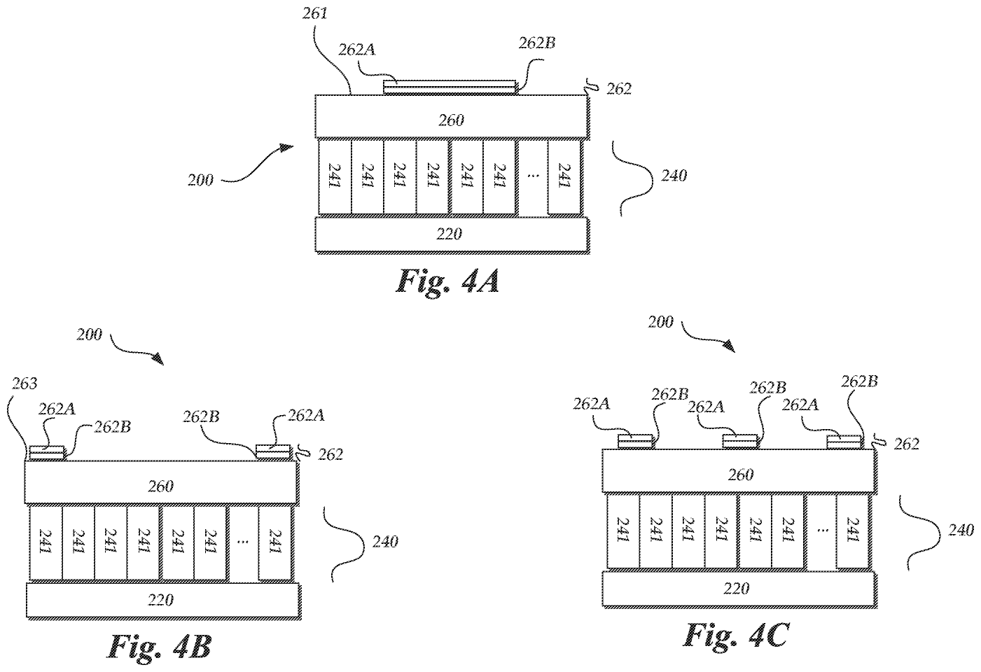

FIGS. 4A, 4B and 4C depict block diagrams representative of the components of a unitary battery pack 200 illustrating examples of integrating impact attenuation layers 262 into unitary battery packs 200 through cross-sectional views in accordance with some embodiments of the present disclosure. As shown in FIG. 4A, the unitary battery pack 200 has a top surface 260, an array of battery cells 240 that includes a plurality of individual cells 241, and a bottom surface 220. The impact attenuation layer 262 is integrated into a portion of the top surface 260 of the unitary battery pack 200, such as by being bonded directly to the top surface 260. The impact attenuation layer 262 has a first sub-layer 262A and a second sub-layer 262B. As illustrated in FIG. 4A, the first sub-layer 262A and the second sub-layer 262B have equal and uniform thicknesses. As shown in FIG. 4A, the impact attenuation layer 262 does not cover the entire area of the top surface 260 but illustratively spreads around the center of the top surface 260. In some embodiments, area of the top surface 260 covered or not covered by the impact attenuation layer 262 are determined based on anticipated locations of potential forces. For example, the area 261 not covered by the impact attenuation layer 262 may be area right under the passenger seats of an electric vehicle or other area where potential forces are less likely to strike. As another example, the impact attenuation layer 262 may be deployed at area where passengers are likely to directly step or tread upon. Alternatively, as illustrated in FIG. 4B, the impact attenuation layer 262 may be deployed around the edge 263 of the top surface 260 as forces external to the vehicle may impact the edge 263 of the top surface 260 more heavily. Additionally, FIG. 4C illustrates another configuration of deploying the impact attenuation layer 262 on the top surface 260 of a unitary battery pack 200. In some embodiments, at least one of the first sub-layer 262A or the second sub-layer 262B may have a non-uniform thickness. Other various distribution of the impact attenuation layer across a top surface of a battery pack should not be construed to fall outside the scope of the present disclosure.

Generally described, the implementation of the impact attenuation layer 262 in the context of the battery pack 200 can provide a more globalized deformation such that impact forces applied to the array of battery cells 240 (or to a plurality of battery cells) can be more widely distributed rather than localized, in contrast to other approaches previously described. For example, it has been noted that globalized deformation attributable to the impact attenuation layer 262 can decrease the potential energy directed to any individual cell 241 in the array of battery cells 240 due to an applied force (such as from an external object or force striking the top surface 260) by at least 65%. In some embodiments, the energy absorption attributable to the impact attenuation layer 262 may limit any potential forces that are applied to the array of battery cells 240. This can mitigate damage or deformation on the array of battery cells 240. Still further, in other aspects, the impact attenuation layer 262 implemented as a part of the top surface 260 may further absorb potential energy from an external object directed toward the battery pack 200 or force striking the bottom surface 220 of the battery pack 200. In some embodiments, the energy absorption attributable to the impact attenuation layer 262 may limit the potential forces transferred between the array of battery cells 240 and the impact attenuation layer 262. This can mitigate damage or deformation associated with the transference of the force (e.g., due to the physical contact of the battery cells 240 and the impact attenuation layer 262).

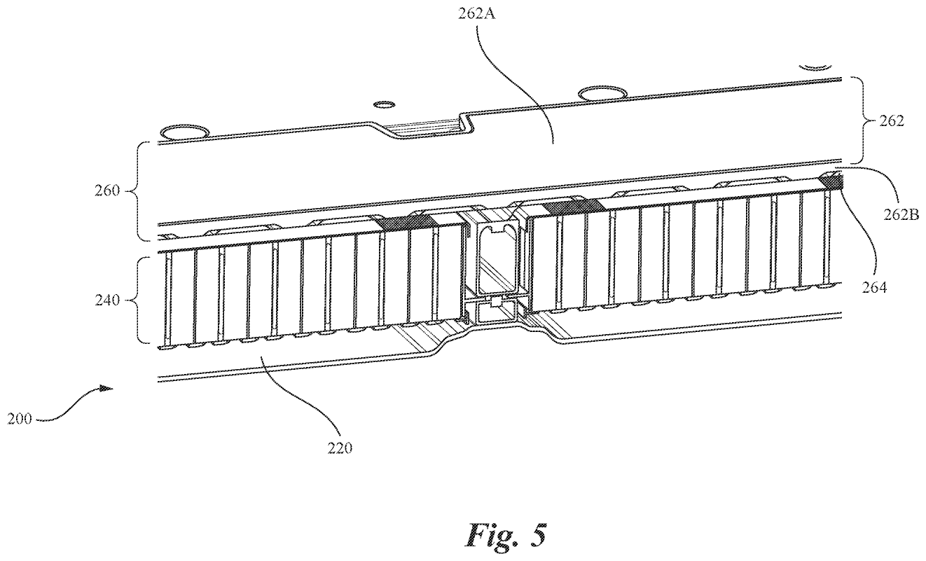

FIG. 5 is a cutaway view of a portion of a unitary battery pack 200 illustrating an array of battery cells 240 (e.g., a plurality of battery cells) forming a portion of the battery pack 200 and an integrated impact attenuation layer 262 in accordance with embodiments of the present disclosure. Integrated onto (or within) the top surface 260 of the battery pack 200 are components (e.g., electrical conductors or busbar that are not explicitly shown) associated with the array of battery cells 240. The cutaway view also illustrates a bottom surface 220 of the battery pack 200 and a vehicle floor 264 for the vehicle. In some embodiments, the top surface 260 may be integrated with the vehicle floor 264. FIG. 5 also illustrates a first sub-layer 262A and a second sub-layer 262B that together form an impact attenuation layer 262, which is a part of the top surface 260, in accordance with one or more aspects of the present application. The first sub-layer 262A may inhibit foreign objects or forces from intruding through the top surface 260 into the array of battery cells 240. The second sub-layer may absorb external impact energy that is directed toward the array of battery cells 240. As illustrated in FIG. 5, the spacing between the array of battery cells 240, the vehicle floor 264, associated electronics/connectors and the impact attenuation layer 262 is illustratively minimized to achieve the spacing benefits described herein as aspects of the present application. In some embodiments, a puncture resistance (or a puncture resistance attribute) of the first sub-layer 262A is higher or greater than a puncture resistance of the second sub-layer 262B; and an impact resistance (or an impact resistance attribute) of the first sub-layer 262A is lower than an impact resistance of the second sub-layer 262B.

In one embodiment, one or more traditional components or attributes of the battery pack 200 may be removed or reduced based on the functionality provided by the impact attenuation layer 262. More specifically, the energy absorption and dissipation properties of the impact attenuation layer 262 can facilitate the reduction or removal of buffering air gaps or other protective layers that exist between the array of battery cells 240 and the top surface 260. As such, the array of battery cells 240 may physically contact the top surface 260. Accordingly, the reduction in traditional surfaces can allow increased electric power capacity of the battery pack, such as by allowing greater dimension for the individual cells in the illustrative battery pack. Advantageously, this can result in greater power output (e.g., increased battery cell dimensions) or stored charge based on maximization of the available space in the battery compartment. In other embodiments, although not shown in FIG. 5, some portion of the additional space not required for buffering or additional protective layers can be utilized to incorporate cooling areas/mechanisms, insulation mechanisms, control mechanisms, sensors or sensing systems, electrical bussing, venting structures, and the like. In addition to achieving integration, these additional components may also be protected by the energy absorption attributes of the impact attenuation layer 262. In some examples, the top surface 260 that is associated with the impact attenuation layer 262 can have different attributes, such as including different materials and thicknesses.

In some embodiments, the first sub-layer 262A and the second sub-layer 262B may be bonded according to the desired height attributes for the impact attenuation layer 262. Bonding can be achieved by suitable adhesive material or mechanism. Additionally, the impact attenuation layer 262 may be bonded to the other components of the vehicle, such as the vehicle floor 264. Additionally, the impact attenuation layer 262 can further provide for acoustic dampening. In some examples, the material used for making the second sub-layer 262B and the thickness of the second sub-layer 262B are chosen to achieve a threshold amount of acoustic dampening attribute. For example, a thickness can be chosen for the second sub-layer 262B such that the second sub-layer 262B can provide a required level of acoustic dampening for a vehicle.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed air vent assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application

What is claimed is:

1. A unitary battery pack, the unitary battery pack comprising:
an array of battery cells;
a battery pack enclosure configured to hold the array of battery cells, wherein the battery pack enclosure comprises a top surface positioned above the array of battery cells; and
an impact attenuation layer integrated into at least a portion of the top surface of the battery pack enclosure, wherein the impact attenuation layer comprises a first sub-layer and a second sub-layer, the first sub-layer having a first puncture resistance attribute and a first impact resistance attribute and the second sub-layer having a second puncture resistance attribute and a second impact resistance attribute,
wherein the first puncture resistance attribute is higher than the second puncture resistance attribute and the first impact resistance attribute is lower than the second impact resistance attribute.

2. The unitary battery pack of claim 1, wherein the battery pack enclosure forms a portion of a floorboard of an electric vehicle.

3. The unitary battery pack of claim 1, wherein the battery pack enclosure is bonded to at least a structure of an electric vehicle.

4. The unitary battery pack of claim 1, wherein the second sub-layer has a thickness and wherein the thickness of the second sub-layer corresponds to an acoustic dampening attribute.

5. The unitary battery pack of claim 1, wherein the first sub-layer of the impact attenuation layer is made of at least one of steel, aluminum, alloy or metallic material.

6. The unitary battery pack of claim 1, wherein the second sub-layer of the impact attenuation layer is made of at least one of polypropylene, epoxy, polyurethane, plastic or foam material.

7. The unitary battery pack of claim 1, wherein the first sub-layer of the impact attenuation layer has a thickness between 0.5 mm to 3.0 mm.

8. The unitary battery pack of claim 1, wherein the second sub-layer of the impact attenuation layer has a thickness between 4.0 mm to 15.0 mm.

9. The unitary battery pack of claim 1, wherein at least one of a thickness of the first sub-layer or a thickness of the second sub-layer is non-uniform.

10. The unitary battery pack of claim 1, wherein the battery pack enclosure further comprises a bottom surface below the array of battery cells, and wherein the bottom surface comprises compressible material that deforms in response to a physical force.

11. The unitary battery pack of claim 1, wherein the first sub-layer and the second sub-layer are bonded with each other.

12. A battery pack, the battery pack comprising:
an array of battery cells;
a battery pack enclosure configured to hold the array of battery cells, the battery pack enclosure comprising:
a bottom surface positioned below the array of battery cells;
a plurality of side surfaces positioned around the array of battery cells; and
a top surface positioned above the array of battery cells; and
an impact attenuation layer integrated into at least a portion of the top surface of the battery pack enclosure, wherein the impact attenuation layer comprises a first sub-layer and a second sub-layer, and wherein the first sub-layer and the second sub-layer are bonded to each other, the first sub-layer having a first puncture resistance attribute and a first impact resistance attribute and the second sub-layer having a second puncture resistance attribute and a second impact resistance attribute,
wherein the first puncture resistance attribute is higher than the second puncture resistance attribute and the first impact resistance attribute is lower than the second impact resistance attribute.

13. The battery pack of claim 12, wherein the bottom surface forms at least one structure that separates one battery cell of the array of battery cells from another battery cell of the array of battery cells.

14. The battery pack of claim 12, wherein a thickness of the first sub-layer is uniform and a thickness of the second sub-layer is uniform.

15. The battery pack of claim 12, wherein at least one of a thickness of the first sub-layer or a thickness of the second sub-layer is non-uniform.

16. An impact attenuation layer configured to attenuate impact to an array of battery cells enclosed by a battery pack enclosure, wherein the impact attenuation layer is integrated into at least a portion of a top surface of the battery pack enclosure, the impact attenuation layer comprising:
a first sub-layer, the first sub-layer having a first puncture resistance attribute and a first impact resistance attribute; and
a second sub-layer, the second sub-layer having a second puncture resistance attribute and a second impact resistance attribute,
wherein the first puncture resistance attribute is higher than the second puncture resistance attribute and the first impact resistance attribute is lower than the second impact resistance attribute.

17. The impact attenuation layer of claim 16, wherein the first sub-layer is made of at least one of steel, aluminum, alloy and metallic material, and wherein the second sub-layer is made of at least one of polypropylene, epoxy, polyurethane, plastic and foam material.

18. The impact attenuation layer of claim 16, wherein the second sub-layer provides acoustic dampening for an electric vehicle.

19. The impact attenuation layer of claim 16, wherein a thickness of the first sub-layer is uniform and a thickness of the second sub-layer is uniform.

20. The impact attenuation layer of claim 16, wherein at least one of a thickness of the first sub-layer or a thickness of the second sub-layer is non-uniform.
